(19) United States
(12) Patent Application Publication
(10) Pub. No.: US 2005/0243392 A1
(43) Pub. Date: Nov. 3, 2005

(54) Method of controlling the motion of a spinner in an imaging device

(75) Inventors: John Robert Hemmings, Bedfordshire (GB); Ian Andrew Gilmour, Herts (GB)

Correspondence Address: SUGHRUE MION, PLLC, 2100 PENNSYLVANIA AVENUE, N.W., SUITE 800, WASHINGTON, DC, 20037, US

(73) Assignee: FUJIFILM ELECTRONIC IMAGING LTD., Hertfordshire (GB)

(21) Appl. No.: 10/836,548

(22) Filed: Apr. 30, 2004

(51) Int. Cl. G02B 26/08

(52) U.S. Cl. 359/196

(57) ABSTRACT

A method of controlling the motion of a spinner in an imaging device is described. The spinner is rotatable at known angular velocity about an axis and moveable in a traverse direction along the axis. The method comprises: receiving an index pulse indicative of a rotational position of the spinner; synchronising the traverse movement of the spinner to the received index pulse; and moving the spinner in the traverse direction such that the spinner arrives at a predetermined target location with the spinner in a predetermined orientation for imaging.

### FIELD OF INVENTION

This invention relates to a method of controlling the motion of a spinner in an imaging device which improves the accuracy of the position of the image scanned onto a record medium. In particular, the start of the image is positioned accurately with respect to the edge of the plate in the slow direction.

### DESCRIPTION OF RELATED ART

Spinners are typically used in imaging devices such as imagesetters or scanners. An imagesetter, for example, is used in an image printing process to transfer an image such as a bitmap onto a record medium such as a printing plate. Typically, the image is stored as a postscript file and then converted to a bitmap using a raster image processor. A typical internal drum imagesetter is shown schematically in FIG. 1. A printing plate 5 is loaded into semi-cylindrical drum 1, covering the internal profiling surface 2. A plate loading mechanism 4 may be used to drive and position the plate 5. A spinner 3 is used to direct a modulated radiation beam 6 which writes image data onto the plate 5. The spinner 3 rotates about its axis so as to scan the beam 6 across the plate 5 in the fast direction F. The spinner 3 is also movable in a traverse direction, out of the plane of the Figure, which moves the beam 6 in the slow direction S. Thus the desired image may be scanned onto the plate 5 by simultaneously revolving the spinner 3 and moving it in a traverse direction. It is desirable to keep these movements independent so that image size scaling can be performed independently in the fast and slow directions.

It is important that the image is accurately positioned on the plate 5 so that minimal adjustment is required during the later stages of the printing process. Since the spinning and traverse movements are independent of one another, there is normally a degree of uncertainty as to where the image begins to be written relative to the plate.

A conventional method of writing an image onto a plate 5 in an imagesetter will now be described with reference to FIG. 2 which shows a plot of the spinner's traverse velocity V (in the slow direction) versus time T. A plate 5 is loaded into drum 1 and the spinner 3 is positioned a small distance before the plate edge (whose position is not yet accurately known). The spinner 3 then rotates about its axis and then starts to move in the traverse direction and accelerates to the imaging velocity, V_{I}. As the spinner 3 crosses the edge of the plate 5, at time T₁, the edge is detected using for example an edge detect laser and light sensitive receiver, and then at some later time T₂ the radiation beam 6 is modulated with image data which is scanned onto the plate 5 by the spinner 3. This continues until the spinner 3 reaches the end of the image region, at time T₃. However, the orientation of the spinner about its axis when it reaches the start of the image region (at time T₂) is unknown. If, as is likely, the spinner 3 is not in the correct angular position, there can be up to a one line error in the slow direction where the image data starts. At 48 lines per millimetre resolution, this corresponds to a 21 micron error which is substantial. This problem becomes even worse in a multibeam imagesetter machine. For example, in a 3-beam machine, three lines are exposed in one revolution of the spinner and the error could be up to 63 microns at 48 lines per millimetre resolution.

Such a method also suffers from poor productivity since the image region may be located a long way from the edge of the plate 5, for example near the centre of the plate or close to the far edge. In such a case, the spinner travelling at the imaging velocity V_{I}, takes a long time to move along the traverse direction into the correct position to start scanning. A further problem is that there may be some latency from detecting the edge of the plate 5 to reading and recording the traverse position of the spinner 3, for example the time taken for a computer interrupt request loop to complete. Furthermore, this error will not be the same at different resolutions since the traverse velocity will be different, and it is therefore difficult to correct.

### SUMMARY OF THE INVENTION

According to the present invention, a method of controlling the motion of a spinner in an imaging device, the spinner being rotatable at known angular velocity about an axis and moveable in a traverse direction along the axis, comprises:
receiving an index pulse indicative of a rotational position of the spinner;
synchronising the traverse movement of the spinner to the received index pulse; and
moving the spinner in the traverse direction such that the spinner arrives at a predetermined target location with the spinner in a predetermined orientation for imaging.

By synchronising the movement of the spinner in the traverse direction with the spinner rotation in this way, at a known later time, the spinner will be orientated in the correct position for the start of imaging in the fast direction and the spinner will be at an accurately known position in the slow direction, travelling with a known traverse velocity. In particular, the predetermined target location of the spinner typically corresponds to that location in the traverse direction where the spinner enters an image region and starts to write image data onto a plate. Thus it is possible to ensure that, at the onset of imaging, the spinner is in the correct orientation and hence the image is accurately positioned on the record medium.

It should be noted that the term “imaging device” includes both devices which write data onto plates (or other media), such as imagesetters, and devices which scan data from media. Likewise, the term “imaging” includes scanning.

Preferably, the method further comprises the step of controlling the velocity of the spinner in the traverse direction such that the spinner undergoes a predetermined number of revolutions in traversing the axial distance between the point at which the traverse movement is synchronised and the target location.

A particular problem associated with the prior art method is that the image start may not be accurately aligned relative to the plate edge in the slow direction. The edge of the plate is typically detected by independent means.

Preferably, the method according to the present invention further comprises the steps of detecting the edge of a plate when loaded into the imaging device; and
controlling the velocity of the spinner in the traverse direction such that the spinner undergoes a predetermined number of revolutions in traversing the axial distance between the edge of the plate and the target location.

This ensures that the spinner can be orientated towards the start of imaging position in the fast direction when the spinner is accurately positioned relative to the plate edge in the slow direction. Once the plate edge is detected, its traverse position can be accurately known and the required position of an image region can be calculated. The traverse velocity of the spinner may then be adjusted such that the time taken to reach the desired image region corresponds to a certain number of spinner revolutions. Thus the spinner can arrive at the target location in the desired rotational orientation, and the image can be accurately positioned in the slow direction. Using this method, the spinner may be continuously moved in the traverse direction, though not necessarily at a constant velocity, thus improving productivity. Preferably, the velocity of the spinner is further controlled such that the spinner is moving along the axis at a predetermined imaging velocity when it reaches the target location. The required imaging velocity depends on the desired resolution and angular velocity of the spinner amongst other factors.

The productivity of the imaging device may be improved by carrying out the edge detection when the spinner is moving in the traverse direction at an edge detection velocity which is greater than the imaging velocity. Similarly, the spinner may be accelerated in the traverse direction once the edge has been detected, and then slowed to reach the target location with the spinner travelling at the desired imaging velocity. This means that the spinner can move faster across regions of the plate which are not to be imaged, thus shortening the overall time taken to process a plate.

Conveniently, the predetermined number of revolutions is an integer. Whilst this simplifies calculation of the required velocity profile, some other number of revolutions could equally well be chosen. For instance, if the edge is detected when the spinner is 180 degrees away from its desired orientation, the predetermined number of revolutions may be n+½ where n is an integer, for example.

Alternatively, the method may further comprise the steps of detecting the edge of a plate when loaded into the imaging device and defining its traverse position;
defining the traverse position of the target location in accordance with the position of the detected edge; and
positioning the spinner in the traverse direction at a start location which is a predetermined distance from the target location, the predetermined distance being selected such that in use the spinner undergoes a predetermined number of revolutions in traversing that distance.

Preferably, the synchronising takes place when the spinner is positioned at the start location.

By selecting such a start location, the required calculations are simplified and thus the accuracy is further improved. Preferably, the predetermined distance is further selected such that the spinner is moving along the axis at a predetermined imaging velocity when it reaches the target location.

It is preferable that the spinner is brought to rest in the traverse direction at the start location. The traverse motion may then be restarted in accordance with the received index pulses only a relatively short distance from the image region. Therefore a relatively small number of spinner revolutions take place before imaging starts, and errors are minimised. The productivity of the imaging device may be improved by detecting the edge of the plate when the spinner is moving in the traverse direction at a detection velocity which is greater than the imaging velocity. Preferably, the method further comprises a step of moving the spinner in the traverse direction at a fast move velocity before the spinner reaches the start location, the fast move velocity being greater than the imaging velocity. In many cases, the fast move velocity will also be greater than the edge detection velocity. The overall time required to process a plate is thus reduced.

Preferably, after the edge of the plate has been detected when the spinner is moving at the edge detection velocity, the spinner is bought to rest in a traverse direction before being accelerated to the fast move velocity. This is convenient since the required position of the start location may be calculated whilst the spinner is at rest, thus simplifying the calculation and improving the accuracy of the start location. Similarly, it is further convenient for the predetermined number of revolutions to be an integer.

Preferably, the index pulses are generated by means of an optical encoder coupled with the spinner. The pulses may alternatively be generated by electrical contacts or a field switching device such as Hall Effect switches within the spinner motor, for example.

It is convenient for movement of the spinner in the traverse direction to be initiated by receipt of an index pulse. However, it may be useful to incorporate some delay into the system, for example starting the traverse movement a certain period of time after receipt of a pulse, or after a fraction of the pulse time period.

Preferably, the method further comprises the steps of detecting the edge of a plate when loaded into the imaging device; measuring the position of the spinner substantially at the instant of detection; and recording the position.

Generally, the edge of the plate is detected using an edge detect system comprising a light source and optical receiver. The light source could be a laser or LED for example, and the receiver could be a photosensitive element such as a photodiode. Alternatively, a light source and a charge coupled device (CCD) or light pipe inserted into the drum surface could be used to detect the position of the plate edge. Generally, the position of the spinner is measured using a traverse optical encoder although other measuring means could be used instead. For example, if a CCD is used to detect the edge, the position of the edge could be determined in accordance with the position of the CCD pixels the detect the shadow of the plate edge.

### BRIEF DESCRIPTION OF DRAWINGS

Examples of methods of controlling the motion of a spinner in an imaging device according to the invention will now be described with reference to the drawings, in which:—

FIG. 1 shows a schematic representation of an internal drum imagesetter;

FIG. 2 shows a typical velocity versus time profile of the spinner in the traverse direction according to a conventional method;

FIG. 3 is a graph showing the timing of the traverse movement compared to the index pulses;

FIG. 4a shows an example of an image plate in plan view;

FIG. 4b shows two possible velocity time profiles for the spinner moving in the traverse direction across the plate shown in FIG. 4a; and

FIGS. 5 and 6 illustrate two further alternative velocity time profiles of the spinner in the traverse direction.

### DESCRIPTION OF PREFERRED EMBODIMENTS

An example will now be described with reference to the control of a spinner in an imagesetter. However, the methods of controlling the spinner are not limited to imagesetters and could equally well be used in another imaging device. The term “imaging” should be taken to include scanning. For example, in a scanner, beam 6 (directed by the spinner 3), would scan data from a plate (or other media) rather than write data onto the media. The gathered data could then be transferred to a computer or disk and stored or otherwise used as required. Use of the methods described below to control the spinner would ensure that the desired portion of the plate (the “scan region”) is accurately scanned.

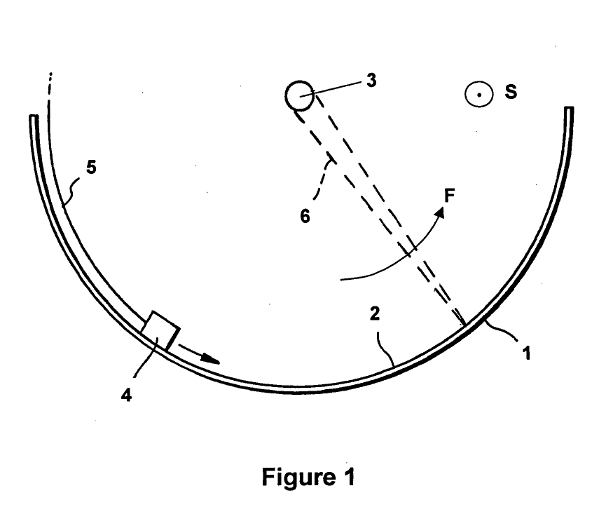

As already described, FIG. 1 shows a conventional imagesetter which scans image data onto plate 5 by means of a modulated radiation beam 6. The beam 6 is scanned by spinner 3. The spinner 3 typically comprises one or more mirrors mounted at 45 degrees to the spinner axis. The mirror or mirrors are mounted on a support coupled to a control system comprising motors which respectively spin the spinner 3 about its axis and which move the spinner 3 in the traverse direction along the axis. The support may also hold apparatus such as an edge detect system.

The traverse system typically is provided with a very accurate optical encoder. An alternative means would be to use a stepper motor running open loop (with no feedback) so that the number of steps determines the traverse position. The optical encoder monitors the spinner's position in the traverse or slow direction. This measurement is used within a feedback loop to control the traverse motor which then gives accurate control over the spinner's traverse position, velocity and acceleration. It is therefore possible to plot a traverse velocity-time profile so that at any particular time the spinner is in an accurately defined traverse position and moving at a known velocity.

The spinner is also provided with an optical encoder or other means which measures the rotational position of the spinner about the axis. Thus the angular velocity of the spinner is also controlled via a feedback loop. The encoder also generates index pulses which give an indication of the spinner's orientation. For example, the encoder may generate one index pulse per revolution, each time the spinner is orientated towards the start of an image line or some known angle away from that orientation. Alternatively, more than one pulse could be generated per revolution. For example, if the spinner comprises two mirrors, it may be useful for one pulse to be generated every half revolution. In any case, the rotational orientation of the spinner with respect to the index pulse must be known so that the image data can be accurately placed in the fast direction.

Synchronisation of the rotational and traverse movement of the spinner is achieved by causing the traverse movement to depend on the index pulses produced by the spinner encoder. For example, by starting the traverse movement on receipt of an index pulse, it is known that after a time T, corresponding to the period of one spin or revolution, the spinner will be in the same rotational orientation as at the start of the motion, but will have moved a certain distance in the traverse direction. The distance moved will depend on the traverse velocity and acceleration of the spinner.

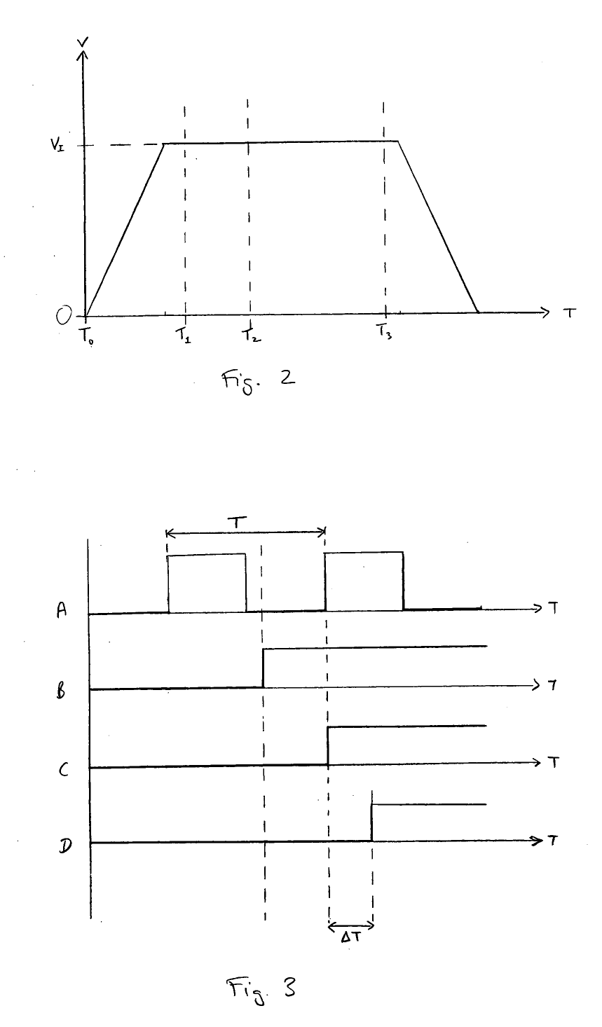

Line A of FIG. 3 shows schematic index pulses generated by the spinner encoder plotted against time. For ease of description, the index pulses are shown as square waves but in practice they could be delta functions, sine waves or any other pulses. When it is desired to start the spinner moving in the traverse direction, a traverse signal may be applied as shown by the line B. However, according to the above-described method, the actual traverse movement will not begin until the next index pulse is received, as indicated by the line C. Alternatively, the system could be adapted so as to include a delay between receipt of an index pulse and start of the traverse movement. For example, as shown by line D, the movement may start a time ΔT after the next pulse has been received. For instance, this may be useful if the index pulse is known to correspond to the spinner being orientation 180 degrees away from the required image start orientation. In this case, the time delay ΔT may correspond to half of the pulse period T. Using any of these methods, at a known later time after the start of the movement, both the rotational and traverse positions of the spinner are accurately known. It is most convenient for the traverse movement to start on receipt of an index pulse (as shown in line C of FIG. 3) since this simplifies calculations.

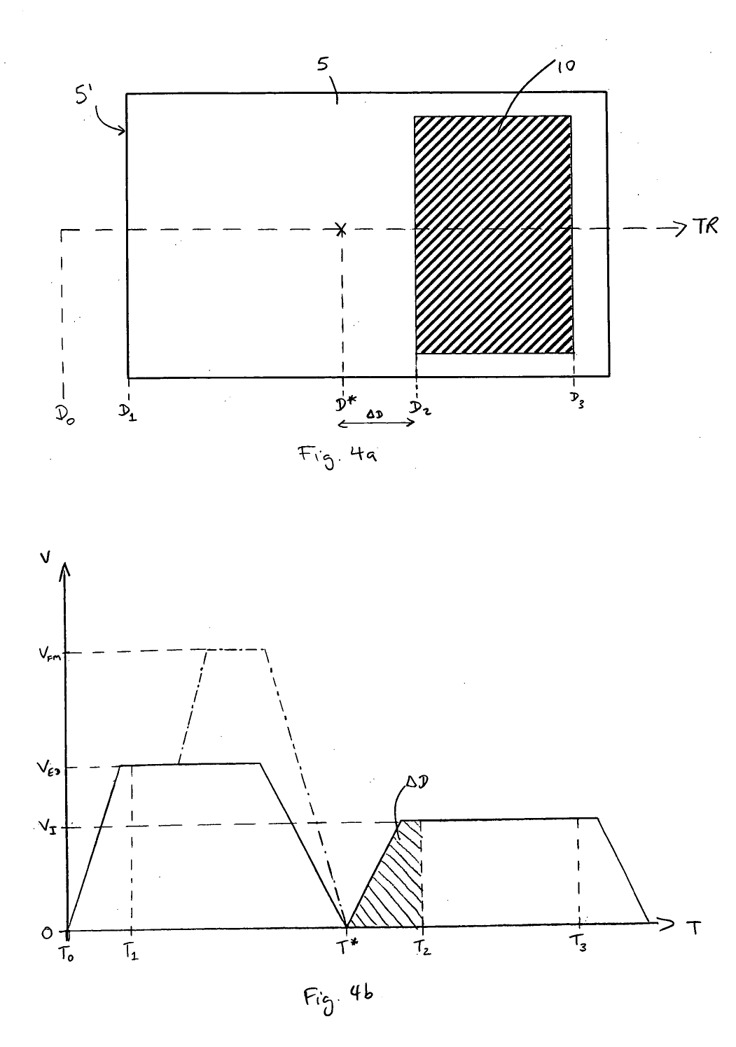

By synchronising the spinning and traverse motions in this way, the method ensures that the spinner arrives at a target location in a desired orientation. By selecting this target location to correspond to the start of an image region on the plate 5, errors in the position in the slow direction may be eliminated. The area of the plate 5 onto which an image is to be scanned may be referred to as the “image region”, shown as item 10 in FIG. 4a. The position of the image region 10 will vary according to the image being printed. FIG. 4a shows an example of a printing plate 5 loaded into the drum 1 of an internal drum imagesetter, in plan view. The spinner 3 is not shown but follows a path along the traverse direction TR. The traverse position of the spinner 3 is measured by the optical encoder provided in the traverse system, relative to an origin which is independent of the position of plate 5. In the following description, the origin will be designated D₀ which corresponds to the starting position of the spinner 3, although this need not be the case.

To determine the traverse position of the image region 10, it is necessary to know the position of plate edge 5′ relative to origin D₀. The plate edge 5′ is conveniently detected using an edge detect system (not shown) such as a laser or LED and optical receiver, such as a photodiode, which may be mounted on the spinner support. For example, the profiling surface 2 may be diffuse and reflective, sending back scattered light to the optical receiver. The surface of plate 5 may be specular, reflecting a narrow beam of light. The angle of the light beam incident to the plate 5 can be arranged such that the reflected beam misses the optical receiver. Thus the absence of reflected light indicates a plate edge. Alternatively, the plate 5 could reflect light into the receiver and the profiling surface 2 could not.

Alternatively, the edge detect system could comprise a light sensitive element such as a CCD or light pipe mounted into the profiling surface 2 and a light source (which may be on the spinner support or elsewhere) for illuminating the element. Depending on the position of plate 5, the light sensitive element could be partially covered. The covered area would not receive light from the light source and could be used to locate the plate edge 5′. For instance, if a CCD array were used, the number of pixels not receiving light could be used to calculate the plate edge position. Further, one or more light sources could be embedded in the profiling surface and the light sensitive element(s) positioned elsewhere.

As the support moves over the plate edge 5′, the edge is detected. The traverse position of the edge (D₁) is then read using the traverse optical encoder, or other measurement means, and stored. The edge detect system is capable of finding the edge very accurately and the traverse position can be read and stored very quickly before the spinner has moved a significant distance. This may be achieved by using an interrupt loop in a computer. Alternatively, the edge detect may trigger the hardware driving the spinner in the traverse direction, which would then read and store the current traverse position. This would remove any latency introduced by the software, reducing errors still further. The stored position could then be transferred to a computer at a later time.

Once the edge position D₁ is known, it is possible to calculate the position D₂ of the start of the image region 10, relative to D₀. The target location of the spinner may then be chosen to correspond to D₂. It is then possible to control the spinner 3 such that it arrives at the target location a set number of revolutions later, thus ensuring the spinner is in the desired orientation when it reaches the target location. There are various ways in which this may be achieved.

It is convenient to bring the spinner to rest some distance before it reaches the target location. In FIG. 4a for example, once the position of the plate edge 5′ (D₁) has been determined, the offset required to move the spinner in the traverse direction to a new position D* can be calculated. The spinner may then be moved to position D* where it is stopped moving in the traverse direction but continues to spin about its axis. The distance between D* and the target location D₂ is selected such that when the spinner 3 moves off from D*, it will complete a predetermined number of revolutions before it reaches the target location at D₂. Thus D* provides a convenient location at which to synchronise the rotational and traverse movements of the spinner as described above with reference to FIG. 3. Hence at D* the spinner is synchronised with the index pulses and begins to accelerate towards the image region.

Once the spinner arrives at the target location D₂, it should be travelling at a desired imaging velocity V_{I}. This velocity will depend on various factors including the desired resolution and scaling of the image. The “start location” D* must therefore be located sufficiently far ahead of the image region 10 to allow the traverse velocity of the spinner 3 to accelerate from rest to the imaging velocity V_{I}, and to complete a certain number of revolutions. Essentially, the spinner should undergo a predetermined number of revolutions in traversing the axial distance between the point where synchronisation starts (in this case, D*) and the point where imaging starts (D₂). It is convenient for an integer number of revolutions to be completed as the spinner moves from D* to D₂ but it may be useful for a non-integer number of revolutions to take place. For example, if the traverse movement is initiated on receipt of an index pulse, but it is known that the index pulse corresponds to the spinner being 180 degrees away from the desired orientation of imaging, the number of revolutions may be chosen to be n+½, where n is an integer. Also, it is possible to take the positioning of the image in the fast direction into account. For example, if the image starts half way across the page in the fast direction, the required number of revolutions may be n+¼ where n is an integer. This would give further accuracy in the positioning of the image relative to the plate edge.

FIG. 4b shows two possible velocity-time profiles of the spinner as it traverses the plate 5 along the traverse direction TR shown in FIG. 4a. The solid line profile will first be described.

The spinner 3 is positioned at D₀ some way ahead of the plate edge 5′. At T₀, the spinner 3 begins to accelerate in the traverse direction. In this case, the start of the traverse motion may or may not be synchronised with the spinner's rotational movement. The spinner 3 accelerates to an edge detection velocity, V_{ED}, at which it crosses the edge of the plate 51 at time T₁. As previously described, the plate edge position D₁ is measured and recorded. The start location D* is then calculated to be a certain distance ΔD ahead of the target location D₂. This distance ΔD includes the distance required for the spinner 3 to accelerate to the imaging velocity V_{I} and to cover an additional distance at V_{I} to ensure that the correct number of revolutions are completed. The distance ΔD corresponds to the shaded area under the velocity time plot in FIG. 4b.

The spinner 3 is brought to rest at the start location D* and then, at time T* the traverse movement is synchronised with the rotational movement (as described above), and the spinner begins to move towards the image region 10. In the example shown, the spinner stops only instantaneously at the start location D*, but in practice the spinner may wait at the start location D* for a period of time. At time T₂, the spinner reaches the target location D₂ with the spinner in the correct orientation and begins to scan the image onto the image region. The scanner travels with constant traverse velocity V_{I} across the image region 10 until time T₃, corresponding to the end point, D₃, of the image region 10, where the spinner stops scanning the image data onto the plate 5.

The edge detection velocity V_{ED} typically corresponds to the fastest velocity that will give reliable edge detect. Since this is generally faster than the imaging velocity V_{I}, the productivity of the imagesetter is improved, because the overall time for the spinner to traverse the plate 5 is decreased. Also, since the edge detection velocity is independent of imaging velocity, any latency in detecting and storing the edge position D₁ can be made constant for all imaging resolutions. This allows the latency error to be calibrated out, thus further improving the accuracy of the method.

The productivity of the imagesetter may be further improved by accelerating the spinner to a greater traverse velocity after the edge has been detected. This is shown by the chain line in FIG. 4b. The fast mode velocity, V_{FM}, is typically as fast as the spinner can reliably traverse whilst keeping track of position. The spinner is then brought to rest at the start location at T* where it is synchronised and goes on to scan the image region.

A preferred velocity time profile is shown in FIG. 5. In this diagram, the times T₀, T₁, T*, T₂ and T₃ all correspond to those times and distances similarly labelled in FIGS. 4a and 4b. The spinner starts moving from position D₀ at time T₀ and accelerates to edge detect velocity V_{ED} to detect the edge 5′ at time T₁. The spinner is then brought to rest at time T₄, which corresponds to a position somewhere between D₁ and D* in FIG. 4a. Whilst the spinner is stopped, the position of the start location D* is calculated. A short while later, at time T₅, the spinner accelerates to the fast mode velocity V_{FM} and then is brought to rest for a second time at the start location D*. FIG. 5 shows the spinner arriving at the start location D* at time T₆ and pausing a short while before synchronising the rotational movement and starting to accelerate to the imaging velocity at time T*. At time T₂ the spinner begins to scan the image onto the plate 5 and this continues until time T₃ when imaging ends and the spinner may be brought to rest. For example, typical timings may be 0.5 seconds to accelerate to the edge detection velocity V_{ED}, 0.7 seconds at V_{ED} to detect the edge 5′ and 0.5 seconds to decelerate to rest. There, the spinner may rest for approximately 0.5 seconds before moving, at T₅, and accelerating for one second to the fast move velocity V_{FM}. It may take between zero and six seconds to move to the start location, D*, where it waits for 0.5 seconds before accelerating to the imaging velocity, V_{I}, and then starts imaging. Of course, these timings could be varied as desired.

It should be noted that for all of the above description, it is assumed that the spinner continues to revolve even when the spinner is stopped in the traverse direction, although this need not be the case. In most cases, the spinner will revolve at a constant angular velocity. Using the methods shown in FIGS. 4b and 5, synchronisation of the rotation and traverse movements need only take place at T*, although the system could be arranged so as to synchronise at T₀ and T₅ as well. The main advantage of the “three move” method shown in FIG. 5 is that velocity, acceleration and distance can be precalculated before each move takes place. The “two move” methods illustrated in FIG. 4b require the acceleration, velocity and start location D* to be calculated whilst the spinner is moving. For this it is necessary to know exactly how long the spinner has been travelling, and how far it has travelled, at each velocity accelerating, resulting in complex calculations.

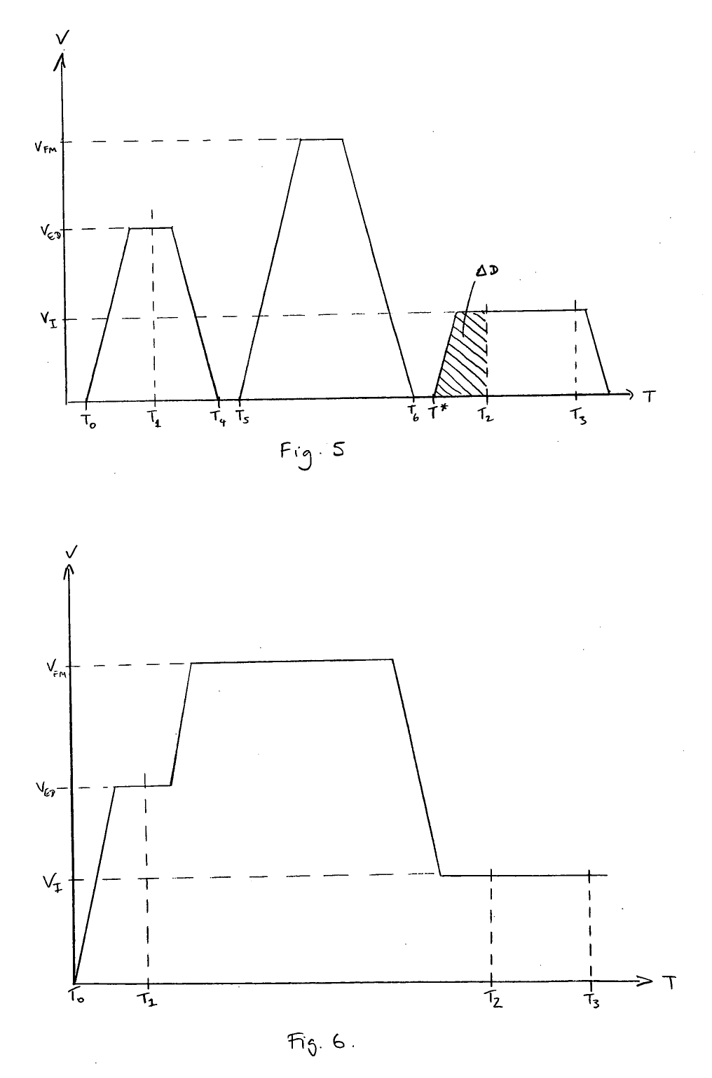

FIG. 6 shows a further example of a velocity-time profile which ensures that the spinner is in the correct orientation when it reaches the target location. In this case, no start location D* is required. Otherwise, the times T₀, T₁, T₂ and T₃, correspond to those in FIGS. 4b and 5. At T₀, the traverse movement is synchronised to the rotation movement of the spinner, and the spinner begins to accelerate to edge detection velocity V_{ED}. The edge of the plate 5 is detected at time T₁. Since the rotational and traverse movements are synchronised, the orientation of the spinner at time T₁ is known. It is therefore possible to calculate how may revolutions are required to put the spinner into the correct orientation when it reaches the start location, and determine a velocity profile that will cause the spinner to arrive at the target location D₂ at the correct time T₂ and in the correct orientation. In effect, this is the same as causing the spinner to undergo a predetermined number of revolutions in traversing the axial distance between the point where synchronisation starts (D₀) and the point where imaging starts (D₂). Typically, the spinner will be accelerated to a fast mode velocity, to improve the imagesetter productivity, before it reaches its target location. Whilst this method maximises productivity (since the spinner does not have to stop until is has finished imaging) the calculations have to be carried out whilst the spinner is moving which is more complex.

In summary, the above-described methods allow accurate placement of the image region 10 relative to the plate edge 5′ in the slow direction. By carrying out the edge detect at a velocity independent of the imaging velocity, errors in the edge detect may be calibrated out and the accuracy further improved.

Whilst the rotational and traverse movements of the spinner are synchronised, each movement remains essentially independent which allows independent control of slow and fast image scaling or resolution. For example, the angular velocity of the spinner could be increased or decreased without adjusting the traverse control since this will depend only on the index pulses. The traverse velocity will not be affected by the change in spin velocity.

Since the spinner is not limited to travelling at the imaging velocity in the traverse direction across the whole plate, the productivity of the imagesetter may be greatly improved.

1. A method of controlling the motion of a spinner in an imaging device, the spinner being rotatable at known angular velocity about an axis and moveable in a traverse direction along the axis, the method comprising:
receiving an index pulse indicative of a rotational position of the spinner;
synchronising the traverse movement of the spinner to the received index pulse; and
moving the spinner in the traverse direction such that the spinner arrives at a predetermined target location with the spinner in a predetermined orientation for imaging.

2. A method according to claim 1, further comprising:
controlling the velocity of the spinner in the traverse direction such that the spinner undergoes a predetermined number of revolutions in traversing the axial distance between the point at which the traverse movement is synchronised and the target location.

3. A method according to claim 1 or claim 2, further comprising:
detecting the edge of a plate when loaded into the imaging device; and
controlling the velocity of the spinner in the traverse direction such that the spinner undergoes a predetermined number of revolutions in traversing the axial distance between the edge of the plate and the target location.

4. A method according to claim 3, wherein the velocity of the spinner is further controlled such that the spinner is moving along the axis at a predetermined imaging velocity when it reaches the target location.

5. A method according to claim 3, wherein when the edge of the plate is detected, the spinner is moving in the traverse direction at an edge detection velocity which is greater than the imaging velocity.

6. A method according to claim 3, wherein the predetermined number of revolutions is an integer.

7. A method according to claim 1, further comprising:
detecting the edge of a printing plate when loaded into the imaging device and defining its traverse position;
defining the traverse position of the target location in accordance with the position of the detected edge; and
positioning the spinner in the traverse direction at a start location which is a predetermined distance from the target location, the predetermined distance being selected such that in use the spinner undergoes a predetermined number of revolutions in traversing that distance.

8. A method according to claim 7 wherein the synchronizing takes place when the spinner is positioned at the start location.

9. A method according to claim 7 wherein the predetermined distance is further selected such that the spinner is moving along the axis at a predetermined imaging velocity when it reaches the target location.

10. A method according to claim 7 further comprising bringing the spinner to rest in the traverse direction at the start location.

11. A method according to claim 7 wherein when the edge of the plate is detected, the spinner is moving in the traverse direction at an edge detection velocity which is greater than the imaging velocity.

12. A method according to claim 7 further comprising moving the spinner in the traverse direction at a fast move velocity before the spinner reaches the start location, the fast move velocity being greater than the imaging velocity.

13. A method according to claim 12 wherein the edge of the plate is detected when the spinner is moving in the traverse direction at an edge detection velocity and the spinner is brought to rest in the traverse direction before the spinner is moved at the fast move velocity.

14. A method according to claim 7 wherein the predetermined number of revolutions is an integer.

15. A method according to claim 1 wherein the index pulses are generated by means of an optical encoder coupled with the spinner.

16. A method according to claim 1 wherein movement of the spinner in the traverse direction is initiated by receipt of an index pulse.

17. A method according to claim 1 further comprising:
detecting the edge of a printing plate when loaded into the imaging device;
measuring the position of the spinner substantially at the instant of detection; and
recording the position.

18. A method according to claim 17 wherein the edge of the plate is detected using an edge detect system comprising a light source and optical receiver.

19. A method according to claim 17 wherein the position of the spinner is measured using a traverse optical encoder.

20. A method according to claim 1, wherein the imaging device is an imagesetter.

21. A method according to claim 1, wherein the imaging device is a scanner.

22. A method according to claim 2, further comprising:
detecting the edge of a plate when loaded into the imaging device; and
controlling the velocity of the spinner in the traverse direction such that the spinner undergoes a predetermined number of revolutions in traversing the axial distance between the edge of the plate and the target location.

23. A method according to claim 22, wherein the velocity of the spinner is further controlled such that the spinner is moving along the axis at a predetermined imaging velocity when it reaches the target location.

24. A method according to claim 22, wherein when the edge of the plate is detected, the spinner is moving in the traverse direction at an edge detection velocity which is greater than the imaging velocity.

25. A method according to claim 22, wherein the predetermined number of revolutions is an integer.
